(19) United States
(12) Patent Application Publication
(10) Pub. No.: US 2024/0348114 A1
(43) Pub. Date: Oct. 17, 2024

(54) INNER ROTOR AND MOTOR

(71) Applicant: KAWASAKI JUKOGYO KABUSHIKI KAISHA, Kobe-shi, Hyogo (JP)

(72) Inventors: Yoshiyasu SHIBAYAMA, Kobe-shi (JP); Keigo IMAMURA, Kobe-shi (JP); Kazuki UETA, Kobe-shi (JP)

(73) Assignee: KAWASAKI JUKOGYO KABUSHIKI KAISHA, Kobe-shi, Hyogo (JP)

(21) Appl. No.: 18/685,339

(22) PCT Filed: Jun. 13, 2022
(86) PCT No.: PCT/JP2022/023673

§ 371 Date: Feb. 21, 2024

(30) Foreign Application Priority Data
Aug. 24, 2021 (WO) PCT/JP2021/031026

(51) Int. Cl. H02K 1/272

(52) U.S. Cl. CPC H02K 1/272

(57) ABSTRACT

An inner rotor includes a rotor body, a polar anisotropic magnet, and magnetic bodies. The rotor body rotates about a rotation axis. The polar anisotropic magnet is located at an outer peripheral surface of the rotor body and has magnetic poles arranged in a circumferential direction centered on the rotation axis. The magnetic bodies are arranged on an outer peripheral surface of the polar anisotropic magnet at positions corresponding to the magnetic poles.

### FIELD

The technique disclosed here relates to an inner rotor and a motor.

### BACKGROUND

Patent Document 1 discloses an inner rotor including a polar anisotropic magnet.

### CITATION LIST

### Patent Document

Patent Document 1: Japanese Patent Application Publication No. 2007-74888

### SUMMARY

The strength of a magnetic field generated by a magnet hardly increases any more once the amount of the magnet exceeds a certain quality. That is, the upper limit of the strength of the magnetic field generated by the magnet depends on physical properties of a magnet material. Thus, it is difficult to increase a motor torque.

It is therefore an object of the technique disclosed here to increase a torque of a motor.

An inner rotor disclosed here includes: a rotor body that rotates about a rotation axis; a polar anisotropic magnet that has magnetic poles arranged in a circumferential direction centered on the rotation axis, the polar anisotropic magnet being located at an outer peripheral surface of the rotor body; and magnetic bodies located at positions corresponding to the magnetic poles on an outer peripheral surface of the polar anisotropic magnet.

A motor disclosed here includes: the inner rotor; and a stator that drives the inner rotor.

The inner rotor can increase a torque of the motor.

The motor can increase a torque of the motor.

### BRIEF DESCRIPTION OF THE DRAWINGS

FIG. 1 is a cross-sectional view of a motor.

FIG. 2 is a cross-sectional view of a polar anisotropic ring magnet and magnetic bodies.

FIG. 3 is an enlarged cross-sectional view of an inner rotor.

FIG. 4 is an enlarged cross-sectional view of the polar anisotropic ring magnet and the magnetic body.

FIG. 5 is an enlarged cross-sectional view of an inner rotor of a first variation.

FIG. 6 is a cross-sectional view of an inner rotor of a second variation.

FIG. 7 is a cross-sectional view of an inner rotor of a third variation.

FIG. 8 is a cross-sectional view of an inner rotor of a fourth variation.

### DESCRIPTION OF EMBODIMENTS

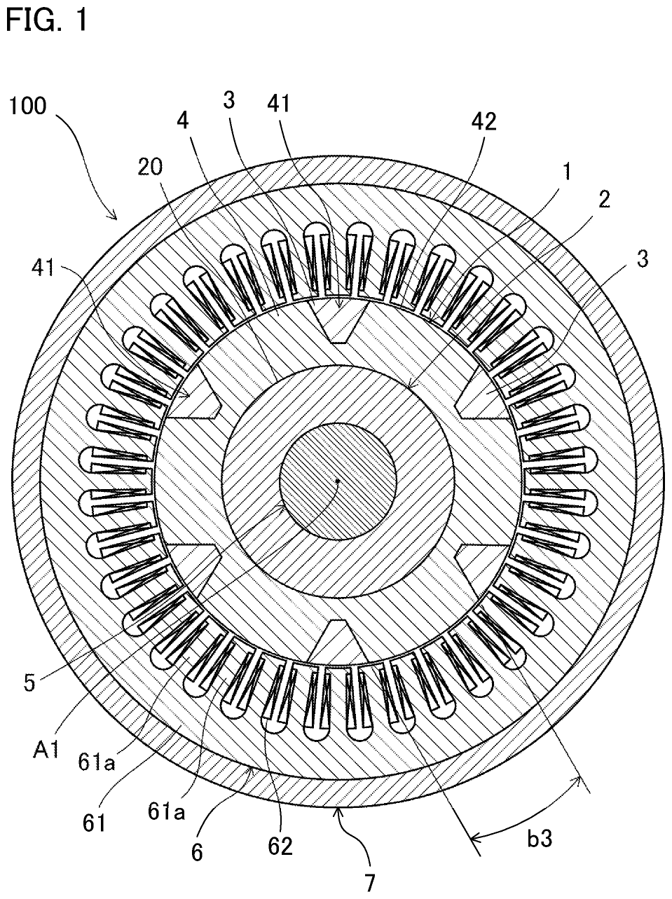

An exemplary embodiment will be described in detail hereinafter with reference to the drawings. FIG. 1 illustrates a motor 100 according to an embodiment. The motor 100 includes a rotor 1 that rotates about a predetermined rotation axis A1, and a stator 6 that rotates the rotor 1 about the rotation axis A1. The rotor 1 is an inner rotor located inside the stator 6. That is, the motor 100 is an inner rotor type motor. The motor 100 may further include a motor case 7. The motor case 7 houses the rotor 1 and the stator 6. The stator 6 is fixed to the motor case 7. The rotor 1 is rotatably supported by the motor case 7.

A direction in which the rotation axis A1 extends will be hereinafter referred to as a “rotation axis direction.” A circumferential direction centered on the rotation axis A1 will be simply referred to as a “circumferential direction.” A radial direction centered on the rotation axis A1 will be simply referred to as a “radial direction.” A side toward the rotation axis A1 in the radial direction will be referred to as a “radially inner side.” A side opposite to the rotation axis A1 in the radial direction will be referred to as a “radially outer side.” A cross section orthogonal to the rotation axis A1 will be simply referred to as an “orthogonal cross section.” A shape of the orthogonal cross section will be simply referred to as a “cross-sectional shape.” A width in the circumferential direction will be simply referred to as a “width.”

The stator 6 includes a stator core 61 and a winding 62. The stator core 61 is a soft magnetic body. The stator core 61 is made of, for example, stacked electromagnetic steel sheets.

The stator core 61 has a ring shape. Specifically, the stator core 61 has a cylindrical shape. The stator core 61 is fixed to the motor case 7. The stator core 61 includes teeth 61a projecting toward the inside of the stator core 61. The teeth 61a are arranged at intervals in the circumferential direction of the stator core 61. The winding 62 is wound around the teeth 61a. When a current is supplied to the winding 62, the stator 6 thereby generates a rotating magnetic field that rotates the rotor 1.

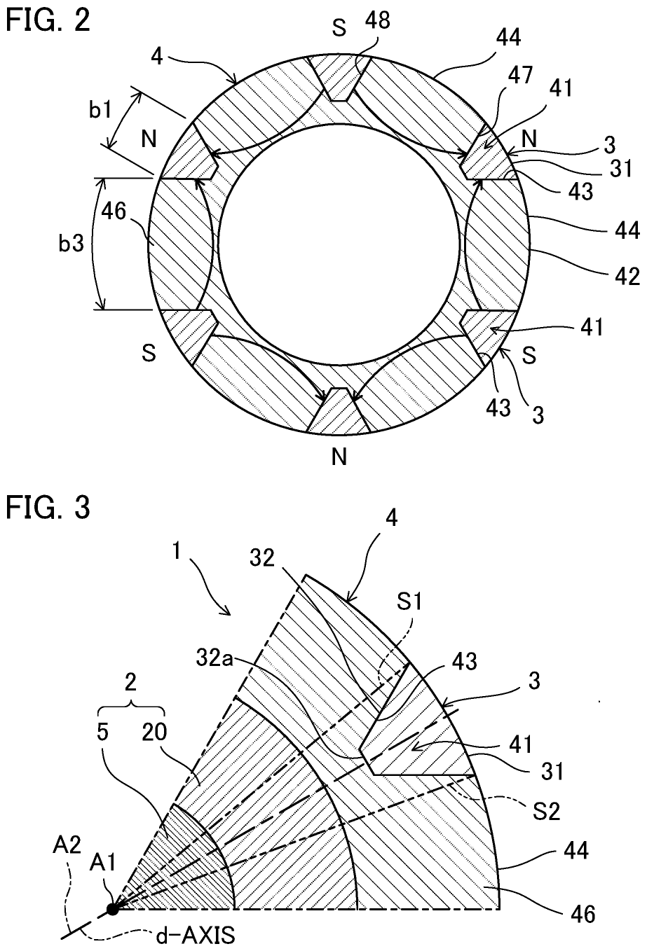

The rotor 1 includes a rotor body 2, a polar anisotropic ring magnet 4, and magnetic bodies 3. The polar anisotropic ring magnet 4 will be hereinafter simply referred to as a “ring magnet 4.” The rotor body 2 rotates about the rotation axis A1. The ring magnet 4 is located at the outer peripheral surface of the rotor body 2. That is, the motor 100 is a surface permanent magnet (SPM) motor. The ring magnet 4 has magnetic poles 41 (see FIG. 2) arranged in the circumferential direction. The ring magnet 4 is an example of a polar anisotropic magnet. The magnetic bodies 3 are located on an outer peripheral surface 42 (i.e., surface at the radially outer side) of the ring magnet 4 and concentrate a magnetic flux of the ring magnet 4.

The rotor body 2 is at least partially made of a soft magnetic body. The rotor body 2 includes a rotor core 20 and a shaft 5. The rotor core 20 is a soft magnetic body. The rotor core 20 is made of, for example, stacked electromagnetic steel sheets. The rotor core 20 has a ring shape surrounding the rotation axis A1. Specifically, the rotor core 20 has a cylindrical shape whose center axis is the rotation axis A1. The outer peripheral surface of the rotor core 20 defines the outer peripheral surface of the rotor body 2. A cross-sectional shape of the rotor core 20 is uniform over the entire length of the rotor core 20 in the rotation axis direction.

The shaft 5 is fitted in the rotor core 20. The shaft 5 is fixed to the rotor core 20. The shaft 5 is a soft magnetic body. The center axis of the shaft 5 coincides with the rotation axis A1. The shaft 5 is rotatably supported by the motor case 7 through a bearing or other members. The rotor core 20 rotates about the rotation axis A1 together with the shaft 5.

The ring magnet 4 is located at the outer peripheral surface of the rotor core 20. The ring magnet 4 has a ring shape surrounding the rotor core 20. Specifically, the ring magnet 4 has a cylindrical shape whose center axis is the rotation axis A1. The ring magnet 4 extends over the entire length of the rotor core 20 in the rotation axis direction. An air gap is present between the outer peripheral surface 42 of the ring magnet 4 and an inner peripheral surface of the stator core 61.

The ring magnet 4 is, for example, a bonded magnet. The bonded magnet is made of a magnet material including magnet powder and a binder for binding the magnet powder. Examples of the magnet powder include powders of magnets such as a neodymium magnet, a samarium iron nitrogen-based magnet, a samarium cobalt-based magnet, a ferrite magnet, and an alnico magnet, and a mixture of two or more of these powders. Examples of the binder include thermosetting resins such as an epoxy resin, thermoplastic resins such as a polyamide resin, and rubber. As the ring magnet 4, a polar anisotropic magnet having a residual flux density of 0.9 T or less is used, for example.

The ring magnet 4 is obtained by insert molding. The ring magnet 4 is obtained by, for example, injecting a magnet material to be a bonded magnet into a molding die housing the rotor core 20 and the magnetic bodies 3.

FIG. 2 is a cross-sectional view of the ring magnet 4 and the magnetic bodies 3. FIG. 3 is an enlarged cross-sectional view of the rotor 1. On the outer peripheral surface 42 of the ring magnet 4, different magnetic poles 41 are alternately arranged in the circumferential direction. In this example, the ring magnet 4 has six magnetic poles 41. The magnetic poles 41 are arranged at regular intervals in the circumferential direction on the outer peripheral surface 42 of the ring magnet 4.

In FIG. 2, arrows inside the ring magnet 4 represent directions of orientation of the ring magnet 4. The ring magnet 4 is oriented in a direction from a south pole that is one of the two magnetic poles 41 adjacent to each other in the circumferential direction toward a north pole that is the other magnetic pole 41. The ring magnet 4 is magnetized such that the magnetization direction coincides with the orientation direction.

The ring magnet 4 concentrates a magnetic flux in a portion of the outer peripheral surface 42 in the circumferential direction. Thus, the ring magnet 4 can increase the magnetic flux density of the magnetic poles 41, as compared to a radial anisotropic magnet. Accordingly, a magnet torque of the motor 100 can be increased.

The outer peripheral surface 42 of the ring magnet 4 has recesses 43 at positions respectively corresponding to the magnetic poles 41. The outer peripheral surface 42 of the ring magnet 4 is defined by curves 44 that coincide with an outer peripheral surface of a single imaginary cylinder whose center axis is the rotation axis A1 and the recesses 43 that are recessed radially inward. The curves 44 and the recesses 43 are alternately arranged in the circumferential direction.

The recesses 43 extend in the rotation axis direction and are open to the radially outer side. The recesses 43 have the same cross-sectional shape. Specifically, the recesses 43 have a substantially trapezoidal cross-sectional shape. The cross-sectional shape of each of the recesses 43 is a line symmetry centered on a symmetric axis A2 extending in the radial direction.

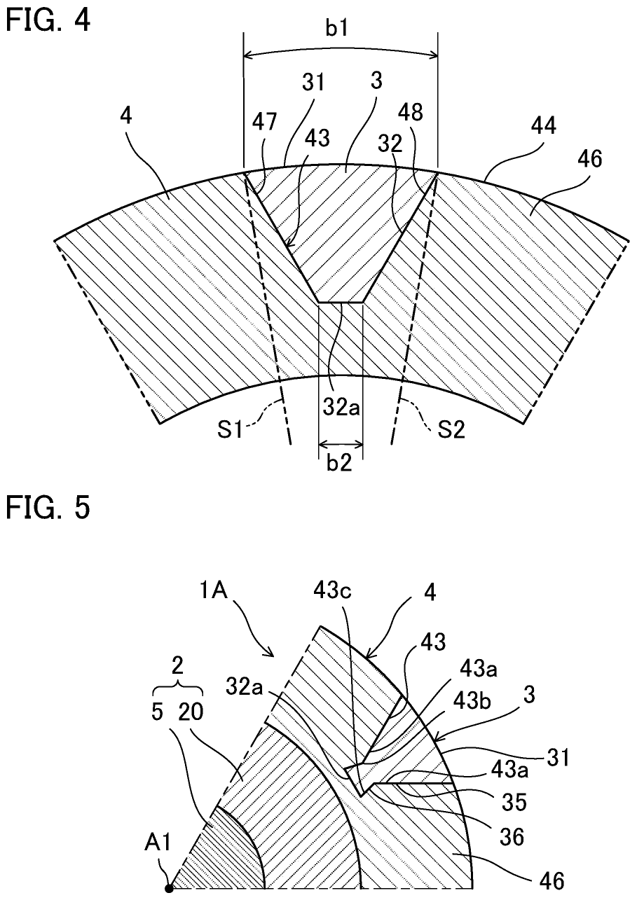

FIG. 4 is an enlarged cross-sectional view of the ring magnet 4 and the magnetic body 3. The width of the recess 43, that is, a dimension between side surfaces of the recess 43 at both sides in the circumferential direction, gradually decreases from the opening of the recess 43 toward the radially inner side. Here, the expression “gradually decrease from the opening of the recess 43 toward the radially inner side” includes not only a decrease of the width of the recess 43 in the entire range of the recess 43 in the radial direction but also a decrease of the width of the recess 43 only in a range from the opening of the recess 43 to an intermediate position of the recess 43 in the radial direction. That is, it is sufficient for the recess 43 to include a width decrease portion in which the width of the recess 43 gradually decreases from the opening toward the radially inner side.

Specifically, the width of the recess 43 gradually decreases from the opening of the recess 43 toward the bottom. That is, in this example, the width decrease portion is present in the entire recess 43. A width b1 of the opening of the recess 43 is a maximum value of the width of the recess 43. A width b2 of the bottom of the recess 43 is a minimum value of the width of the recess 43. The width b1 is greater than or equal to twice as large as the width b2. Specifically, the width b1 is greater than or equal to three times as large as the width b2. The width b1 is smaller than a width b3 (see FIG. 1) of a portion of the outer peripheral surface 42 of the ring magnet 4 between the recesses 43 adjacent to each other in the circumferential direction. The portion of the ring magnet 4 between the recesses 43 adjacent to each other in the circumferential direction will be hereinafter referred to as a “projection 46.”

The other portion of the recess 43 except for the opening is located at the inner side of the both edges of the opening of the recess 43 in the circumferential direction. Specifically, a line segment connecting one edge of the opening of the recess 43 in the circumferential direction to the rotation axis A1 is a first straight line S1, and a line segment connecting the other edge of the opening of the recess 43 in the circumferential direction to the rotation axis A1 is a second straight line S2. The recess 43 includes side surfaces 47 and 48 at both sides in the circumferential direction. The first side surface 47 that is one of the side surfaces of the recess 43 at both sides in the circumferential direction toward the first straight line S1 tilts with respect to the first straight line S1 such that the first side surface 47 gradually diverges from the first straight line S1 toward the second straight line S2 as the first side surface 47 approaches the radially inner side. The second side surface 48 that is one of the side surfaces of the recess 43 at both sides in the circumferential direction toward the second straight line S2 tilts with respect to the second straight line S2 such that the second side surface 48 gradually diverges from the second straight line S2 toward the first straight line S1 as the second side surface 48 approaches the radially inner side.

In this example, the first side surface 47 of one of the recesses 43 adjacent to each other in the circumferential direction is parallel to the second side surface 48 of the other recess 43. Specifically, one of the recesses 43 adjacent to each other in the circumferential direction is defined as a first recess 43 and the other recess 43 is defined as a second recess 43. The first side surface 47 that is one of the side surfaces of the first recess 43 toward the second recess 43 is parallel to the second side surface 48 that is one of the side surfaces of the second recess 43 toward the first recess 43. Thus, the width of the projection 46 of the ring magnet 4 in the circumferential direction is substantially uniform in the radial direction of the projection 46. The term “parallel” herein refers to substantially parallel. That is, “parallel” includes a slight tilt due to dimensional errors or other reasons, as well as strict parallel.

The magnetic bodies 3 are located at positions corresponding to the magnetic poles 41 (i.e., recesses 43) of the ring magnet 4. In this example, the rotor 1 includes the magnetic bodies 3 in the same number as the magnetic poles 41. The magnetic bodies 3 are located at positions corresponding to all the magnetic poles 41.

The magnetic bodies 3 are soft magnetic bodies. Each of the magnetic bodies 3 is made of, for example, stacked electromagnetic steel sheets. The magnetic bodies 3 has a magnetic permeability higher than that of the air. Thus, it is difficult for a magnetic flux of the ring magnet 4 to pass through the air gap, and the magnetic flux intensively moves in and out of the magnetic bodies 3. That is, the magnetic bodies 3 are portions where the magnetic flux of the ring magnet 4 moves in and out most intensively in the rotor 1.

The magnetic bodies 3 are fitted in the recesses 43 of the ring magnet 4. The magnetic bodies 3 has the same cross-sectional shape as the cross-sectional shape of the recesses 43. That is, each of the magnetic bodies 3 has a substantially trapezoidal cross-sectional shape. The cross-sectional shape of each of the magnetic bodies 3 is a line symmetry about a symmetric axis A2 (see FIG. 3) extending in the radial direction. A d-axis that is a magnetic center axis of the rotor 1 passes through each magnetic body 3. Specifically, the d-axis passes through the magnetic body 3 and coincides with the symmetric axis A2.

Each of the magnetic body 3 includes the outer surface 31 exposed from the recess 43 to the radially outer side, and an inner surface 32 located inside the recess 43. The outer surface 31 faces the stator 6. The outer surface 31 flushes with the curve 44 of the ring magnet 4. Specifically, the outer surface 31 defines an outer peripheral surface of a single imaginary cylinder whose center axis is the rotation axis A1 together with the curve 44. The outer peripheral surface of the rotor 1 is defined by the curve 44 and the outer surface 31.

The inner surface 32 of each magnetic body 3 is in close contact with the inner surface (i.e., magnetic pole 41) of the recess 43 of the ring magnet 4. The magnetic body 3 is fixed to the ring magnet 4. The magnetic body 3 is fixed to the ring magnet 4 by connecting the inner surface 32 to the inner surface of the recess 43 in integrally molding the ring magnet 4 with the magnetic body 3, for example. The inner surface 32 includes a bottom surface 32a that is a surface of the magnetic body 3 opposite to the outer surface 31.

The width of each magnetic body 3, that is, a dimension between side surfaces of the magnetic body 3 at both sides in the circumferential direction, gradually decreases from the outer surface 31 toward the radially inner side. Specifically, the width of the magnetic body 3 gradually decreases from the outer surface 31 toward the bottom surface 32a. The width of the outer surface 31 is equal to the width b1 of the opening of the recess 43. The width of the outer surface 31 is the maximum value of the width of the magnetic body 3. The width of the bottom surface 32a is equal to the width b2 of the bottom portion of the recess 43. The width of the bottom surface 32a is a minimum value of the width of the magnetic body 3.

When a current is supplied to the winding 62 of the stator 6 to generate a rotating magnetic field, a magnetic flux generated by the ring magnet 4 interlinks with the winding 62 so that a magnet torque occurs. Accordingly, the rotor 1 rotates about the rotation axis A1.

The magnetic flux density of the ring magnet 4 hardly increases any more once the magnet amount of the ring magnet 4 exceeds a certain quantity. That is, the upper limit of the magnetic flux density of the magnetic poles 41 depends on physical properties of the ring magnet 4. Specifically, the upper limit of the magnetic flux density of the ring magnet 4 depends on the residual flux density of the material for the ring magnet 4. However, in the rotor disclosed here, since the magnetic bodies 3 are located at the respective magnetic poles 41 of the ring magnet 4, the magnetic flux of the ring magnet 4 intensively moves in and out of the magnetic body 3. Thus, the upper limit of the magnetic flux density of portions of the outer peripheral surface of the rotor 1 corresponding to the magnetic poles 41 depends on the saturation magnetic flux density of the material for the magnetic bodies 3. In view of this, when the rotor disclosed here employs magnetic bodies 3 having high saturation magnetic flux density, the magnetic flux density increases. Consequently, a magnet torque of the motor 100 is increased, and as a result, a torque of the motor 100 is increased.

The magnetic bodies 3 are located in the recesses 43 on the outer peripheral surface 42 of the ring magnet 4. Thus, the magnetic bodies 3 can be placed in the ring magnet 4 such that the magnetic bodies 3 do not project from the curves 44 of the ring magnet 4 to the radially outer side. In this case, an air gap between the curves 44 of the ring magnet 4 and the stator 6 can be reduced. Accordingly, a magnetic flux generated in the stator 6 easily flows to the rotor 1 so that a torque of the motor 100 can be thereby increased. The outer surface 31 of the magnetic bodies 3 flushes with the curves 44 of the ring magnet 4, and no steps are present between the outer surface 31 and the curves 44 at the outer peripheral surface of the rotor 1. Thus, air resistance during rotation of the rotor 1 decreases, and the rotor 1 rotates efficiently.

The width of each of the recesses 43 gradually decreases from the opening of the recess 43 toward the radially inner side. Thus, the volume of a portion of the ring magnet 4 adjacent to the recess 43 in the circumferential direction is enlarged toward the recess 43 so that the magnet amount of this portion can be thereby increased. Specifically, the volume of the projection 46 of the ring magnet 4 is enlarged toward the recess 43 in the circumferential direction so that the magnet amount of the projection 46 can be thereby increased. As a result, a magnet torque of the motor 100 can be increased. In addition, the width of the opening of the recess 43 increases so that the width of the outer surface 31 of the magnetic body 3 can be thereby increased. Thus, magnetic saturation hardly occurs on the outer surfaces 31 of the magnetic bodies 3, and a magnetic flux concentrated from the ring magnet 4 to the magnetic bodies 3 easily moves in and out of the outer surfaces 31. As a result, a magnet torque of the motor 100 can be further increased.

In particular, the first side surface 47 of one of the recesses 43 adjacent to each other in the circumferential direction is parallel to the second side surface 48 of the other recess 43. Thus, while a sufficient width of the outer surface 31 of each magnetic body 3 is kept, a sufficient magnet amount is obtained in the projection 46, that is, in a portion of the ring magnet 4 between the recesses 43 adjacent to each other in the circumferential direction can be obtained. As a result, a magnet torque of the motor 100 can be further increased.

Next, rotors 1A through 1D according to first through fourth variations will be described. Basic configurations of the rotors 1A through 1D are the same as that of the rotor 1. Thus, aspects of the rotors 1A through 1D different from the rotor 1 will be mainly described below.

FIG. 5 is an enlarged cross-sectional view of the rotor 1A of the first variation. A ring magnet 4 of the rotor 1A includes stoppers 43a projecting toward the inside of a recess 43 in the circumferential direction to restrict movement of a magnetic body 3 to the radially outer side. In this example, the ring magnet 4 includes two stoppers 43a. The stoppers 43a are integrated with the ring magnet 4. The two stoppers 43a are located at side surfaces of the recess 43 at both sides in the circumferential direction, and are opposed to each other. The two stoppers 43a are obtained by reducing the width of an intermediate portion 43b of the recess 43 in the radial direction. Specifically, the width of a portion of the recess 43 at the radially outer side of the intermediate portion 43b in the radial direction decreases toward the radially inner side. That is, the width of the portion of the recess 43 at the radially outer side of the intermediate portion 43b in the radial direction decreases as the portion approaches the radially inner side. The width of a portion of the recess 43 at the radially inner side of the intermediate portion 43b increases toward the radially inner side. That is, the width of the portion of the recess 43 at the radially inner side of the intermediate portion 43b increases as the portion approaches the radially inner side. In this manner, the two stoppers 43a whose tops are the intermediate portion 43b are obtained.

Each of the magnetic bodies 3 includes a body 35 located radially outward of the intermediate portion 43b of the recess 43, and a wide portion 36 located radially inward of the intermediate portion 43b. A cross-sectional shape of the body 35 coincides with a cross-sectional shape of a portion located radially outward of the intermediate portion 43b of the recess 43. Specifically, the body 35 has a substantially trapezoidal cross-sectional shape. The width of the body 35 decreases toward the radially inner side.

The wide portion 36 projects radially inward from the body 35. A maximum value of the width of the wide portion 36 is larger than a distance between the two stoppers 43a in the circumferential direction, that is, the width of the intermediate portion 43b of the recess 43. A cross-sectional shape of the wide portion 36 coincides with a cross-sectional shape of a portion of the recess 43 located radially inward of the intermediate portion 43b. Specifically, the wide portion 36 has a trapezoidal cross-sectional shape. The width of the wide portion 36 increases toward the radially inner side. A radially inner surface of the wide portion 36 serves as a bottom surface 32a of the magnetic body 3. The width of the bottom surface 32a is the maximum value of the width of the wide portion 36. The width of the bottom surface 32a is smaller than the width of an outer surface 31 that is a radially outer surface of the body 35.

When the magnetic body 3 receives a centrifugal force during rotation of the rotor 1, movement of the wide portion 36 to the radially outer side is restricted by the stoppers 43a. That is, the magnetic body 3 is retained by the stoppers 43a. Thus, detachment of the magnetic bodies 3 from the ring magnet 4 can be prevented.

In the projection 46 of the ring magnet 4, the magnet amount of a radially outer portion close to the stator 6 significantly affects a magnet torque. In other words, even when the magnet amount of a radially inner portion of the projection 46 of the ring magnet 4 away from the stator 6 decreases to some extent, a magnet torque does not significantly decrease. Thus, although the recess 43 includes the wide portion 43c that houses the wide portion 36, a magnet torque does not easily decrease. That is, since the portion 43c is located at the radially inner end of the recess 43, the magnet amount of a radially inner portion of the projection 46 decreases. However, the magnet amount in a radially outer portion of the projection 46 that significantly effects a magnet torque does not decrease. Accordingly, a magnet torque of the motor 100 can be maintained.

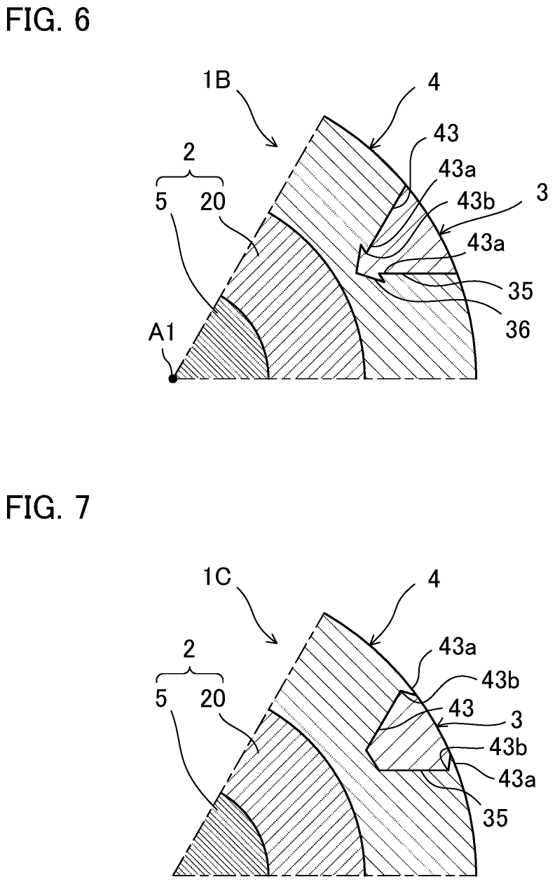

FIG. 6 is an enlarged cross-sectional view of the rotor 1B of the second variation. In this example, a shape of a wide portion 36 of a magnetic body 3 is different from a shape of the wide portion 36 of the first variation. Aspects of the rotor 1B different from the rotor 1A will be mainly described below.

A portion of the recess 43 located radially inward of the intermediate portion 43b has a triangular cross-sectional shape. The width of the portion of the recess 43 located radially inward of the intermediate portion 43b decreases toward the radially inner side. The cross-sectional shape of the wide portion 36 of the magnetic body 3 coincides with the cross-sectional shape of the portion of the recess 43 located radially inward of the intermediate portion 43b. That is, the wide portion 36 of the magnetic body 3 has a triangular cross-sectional shape. The width of the wide portion 36 decreases toward the radially inner side.

In this example, when the magnetic body 3 receives a centrifugal force during rotation of the rotor 1, movement of the wide portion 36 to the radially outer side is also restricted by the stoppers 43a.

FIG. 7 is a cross-sectional view of the rotor 1C of the third variation. In this example, two stoppers 43a are obtained by making the width of a radially outer end portion of a recess 43 smaller than that of the other portion. Specifically, the width of the portion of the recess 43 located radially outward of the intermediate portion 43b in the radial direction decreases toward the radially outer side. The width of a portion of the recess 43 located radially inward of the intermediate portion 43b decreases toward the radially inner side. Accordingly, portions of the recess 43 located radially outward of the intermediate portion 43b serve as the stoppers 43a. The width of the opening of the recess 43 is smaller than the width of the intermediate portion 43b. The width of the opening of the recess 43 is larger than the width of a radially inner end portion of the recess 43, that is, a minimum value of the width of a portion of the recess 43 located radially inward of the intermediate portion 43b in the radial direction.

The cross-sectional shape of the magnetic body 3 coincides with the cross-sectional shape of the recess 43. That is, the magnetic body 3 includes a portion whose cross-sectional shape coincides with the cross-sectional shape of the portion of the recess 43 located radially inward of the intermediate portion 43b, and a portion whose cross-sectional shape coincides with the cross-sectional shape of a portion of the recess 43 located radially outward of the intermediate portion 43b.

In this example, when the magnetic body 3 receives a centrifugal force during rotation of the rotor 1, movement of the magnetic body 3 to the radially outer side is also restricted by the stoppers 43a.

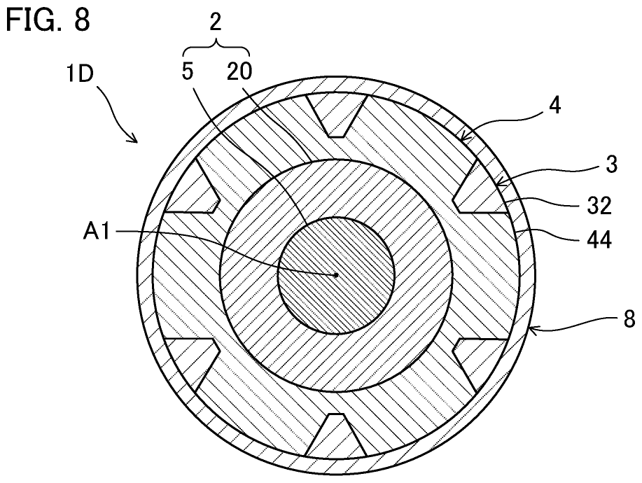

FIG. 8 is a cross-sectional view of the rotor 1D of the fourth variation. The rotor 1D further includes a stopper member 8 that stops detachment of the magnetic body 3 in the recess 43. The stopper member 8 is a non-magnetic body such as stainless or fiber-reinforced plastics (FRP) or a magnetic body such as iron or steel, for example. The stopper member 8 has a ring shape surrounding the ring magnet 4. Specifically, the stopper member 8 has a cylindrical shape whose center axis is the rotation axis A1. The stopper member 8 is fixed to the ring magnet 4 with an inner peripheral surface of the stopper member 8 being in contact with a curve 44 of the ring magnet 4 outer surfaces 31 of the magnetic bodies 3. The stopper member 8 restricts radially outward movement of the magnetic bodies 3 subjected to a centrifugal force during rotation of the rotor 1. Accordingly, the magnetic bodies 3 are not easily detached from the ring magnet 4.

### Other Embodiments

In the foregoing section, the embodiment and the variations thereof have been described as examples of the technique disclosed in the present application. The technique disclosed here, however, is not limited to these examples, and is applicable to other embodiments obtained by changes, replacements, additions, and/or omissions as necessary. Components described in the embodiment and the variations thereof may be combined as a new embodiment. Components provided in the accompanying drawings and the detailed description can include components unnecessary for solving problems as well as components necessary for solving problems in order to exemplify the technique. Therefore, it should not be concluded that such unnecessary components are necessary only because these unnecessary components are included in the accompanying drawings or the detailed description.

For example, the rotor body 2 may not include the shaft 5 and may be made only of the rotor core 20. The rotor body 2 may not include the rotor core 20 and may be made only of the shaft 5. The shaft 5 may not be a soft magnetic body. The shaft 5 may be integrated with the rotor core 20.

The residual flux density of the ring magnet 4 is not limited to 0.9 T or less, and may exceed 0.9 T. The ring magnet 4 is not limited to the bonded magnet, and may be a sintered magnet obtained by sintering magnetic powder, for example. In this case, examples of the magnetic powder include powders of magnets such as a neodymium magnet, a samarium iron nitrogen-based magnet, a samarium cobalt-based magnet, a ferrite magnet, and an alnico magnet, and a mixture of two or more of these powders. The ring magnet 4 may be a single polar anisotropic magnet continuous in the circumferential direction, or may be polar anisotropic magnets divided in the circumferential direction.

The number of the magnetic poles 41 in the ring magnet 4 is not particularly limited. The shape of the recesses 43 of the ring magnet 4 is not particularly limited. For example, the width of the recesses 43 may be uniform in the radial direction of the recesses 43. The width of each of the recesses 43 may increase toward the radially inner side. The recesses 43 of the ring magnet 4 may be omitted. For example, the outer peripheral surface 42 of the ring magnet 4 may be a curve that coincides with an outer peripheral surface of an imaginary columnar, and the magnetic bodies 3 are located on this curve.

The number of the magnetic bodies 3 included in each of the rotors 1 and 1A through 1D is not particularly limited. The magnetic bodies 3 may be located only at a part of the magnetic bodies 41 in the ring magnet 4. The shape of the magnetic bodies 3 is not particularly limited. The outer surfaces 31 of the magnetic bodies 3 may not flush with the curves 44 of the ring magnet 4. The outer surface 31 of the magnetic bodies 3 may project radially outward of the curves 44 of the ring magnet 4, or may be recessed radially inward of the curves 44 of the ring magnet 4.

In the manner described above, each of the rotors 1 and 1A through 1D (inner rotor) according to a first aspect of the technique of the present disclosure includes: the rotor body 2 that rotates about the rotation axis A1; the ring magnet 4 (polar anisotropic magnet) that has the magnetic poles 41 arranged in the circumferential direction centered on the rotation axis A1, the ring magnet 4 being located at the outer peripheral surface of the rotor body 2; and the magnetic bodies 3 located at positions corresponding to the magnetic poles 41 on the outer peripheral surface 42 of the ring magnet 4.

With this configuration, a magnetic flux of the ring magnet 4 intensively moves in and out of the magnetic bodies 3 located at the magnetic poles 41 of the ring magnet 4. Accordingly, the magnetic flux density of portions of the outer peripheral surface of the rotor 1 corresponding to the magnetic poles 41 can be increased. Consequently, a magnet torque of the motor 100 is increased, and as a result, a torque of the motor is increased.

In each of the rotors 1 and 1A through 1D according to a second aspect of the technique of the present disclosure, in the rotors 1 and 1A through 1D of the first aspect, the outer peripheral surface 42 of the ring magnet 4 has the recesses 43 at positions corresponding to the magnetic poles 41, and the magnetic bodies 3 are located in the recesses 43.

With this configuration, the magnetic bodies 3 do not project from the ring magnet 4 radially outward and an air gap between the ring magnet 4 and the stator 6 can be reduced. Accordingly, a magnetic flux generated in the stator 6 easily flows to the rotor 1 so that a torque of the motor 100 can be thereby increased.

In each of the rotors 1, 1A, 1B, and 1D according to a third aspect of the technique of the present disclosure in the rotors 1, 1A, 1B, and 1D of the second aspect, a width of each of the recesses 43 in the circumferential direction decreases from an opening of the recess 43 toward an inner side in a radial direction centered on the rotation axis A1.

With this configuration, the volume of a portion of the ring magnet 4 adjacent to each recess 43 in the circumferential direction is enlarged toward the recess 43 so that the magnet amount of this portion can be thereby increased. As a result, a magnet torque of the motor 100 can be increased. In addition, the width of the opening of the recess 43 in the circumferential direction increases so that the width of the outer surface 31 of the magnetic body 3 in the circumferential direction exposed from the recess 43 can be thereby increased. Thus, magnetic saturation hardly occurs on the outer surfaces 31 of the magnetic bodies 3, and a magnetic flux concentrated from the ring magnet 4 to the magnetic bodies 3 easily moves in and out of the outer surfaces 31. As a result, a magnet torque of the motor 100 can be further increased.

In each of the rotors 1, 1A, 1B, and 1D according to a fourth aspect of the technique of the present disclosure, in the rotors 1, 1A, 1B, and 1D of the third aspect, the first recess 43 that is one of the recesses 43 adjacent to each other in the circumferential direction has the first side surface 47 that is the side surface toward the second recess 43, the second recess 43 being the other one of the recesses 43 adjacent to each other in the circumferential direction, the second recess 43 has the second side surface 48 that is the side surface toward the first recess 43, and the first side surface 47 and the second side surface 48 are parallel to each other.

With this configuration, the first side surface 47 and the second side surface 48 are parallel. Thus, while a sufficient width of the outer surface 31 of each magnetic body 3 is obtained, a sufficient magnet amount is obtained in a portion of the ring magnet 4 between the recesses 43 adjacent to each other in the circumferential direction. As a result, a magnet torque of the motor 100 can be further increased.

In the rotors 1A through 1C according to a fifth aspect of the technique of the present disclosure, in the rotors 1A through 1C of any one of the second through fourth aspects, the ring magnet 4 includes the stoppers 43a each of which projects toward the inner side of a corresponding one of the recesses 43 in the circumferential direction and restricts outward movement of a corresponding one of the magnetic bodies 3 in the radial direction centered on the rotation axis A1.

With this configuration, when the magnetic body 3 receives a centrifugal force during rotation of the rotor 1, movement of the magnetic body 3 to the radially outer side is also restricted by the stoppers 43a. Thus, during rotation of the rotor 1, detachment of the magnetic bodies 3 from the ring magnet 4 can be prevented.

The motor 100 according to a sixth aspect of the technique of the present disclosure include: the rotor 1 and 1A through 1D of any one of the first through fifth aspects; and the stator 6 that drives the rotors 1 and 1A through 1D.

With this configuration, a magnet torque of the motor 100 is increased, and as a result, a torque of the motor is increased.

### REFERENCE SIGNS LIST

100 motor
1, 1A through 1D inner rotor
2 rotor body
3 magnetic body
4 ring magnet (polar anisotropic magnet)
41 magnetic pole
42 outer peripheral surface
43 recess
43 stopper
47 first side surface
48 second side surface
6 stator
A1 rotation axis

1. An inner rotor comprising:
a rotor body that rotates about a rotation axis;
a polar anisotropic magnet that has magnetic poles arranged in a circumferential direction centered on the rotation axis, the polar anisotropic magnet being located at an outer peripheral surface of the rotor body; and
magnetic bodies located at positions corresponding to the magnetic poles on an outer peripheral surface of the polar anisotropic magnet.

2. The inner rotor according to claim 1, wherein
the outer peripheral surface of the polar anisotropic magnet has recesses at positions corresponding to the magnetic poles, and
the magnetic bodies are located in the recesses.

3. The inner rotor according to claim 2, wherein
a width of each of the recesses in the circumferential direction decreases from an opening of the recess toward an inner side in a radial direction centered on the rotation axis.

4. The inner rotor according to claim 3, wherein
a first recess that is one of the recesses adjacent to each other in the circumferential direction has a first side surface that is a side surface toward a second recess, the second recess being the other one of the recesses adjacent to each other in the circumferential direction,
the second recess has a second side surface that is a side surface toward the first recess, and
the first side surface and the second side surface are parallel to each other.

5. The inner rotor according to claim 2, wherein
the polar anisotropic magnet includes stoppers each of which projects toward an inner side of a corresponding one of the recesses in the circumferential direction and restricts outward movement of a corresponding one of the magnetic bodies in a radial direction centered on the rotation axis.

6. A motor comprising:
the inner rotor according to claim 1; and
a stator that drives the inner rotor.
